(19) United States
(12) Patent Application Publication
(10) Pub. No.: US 2006/0285899 A1
(43) Pub. Date: Dec. 21, 2006

(54) Waste toner vibration device

(75) Inventor: Steven Christopher Dianetti, Brighton, NY (US)

Correspondence Address: PILLSBURY WINTHROP SHAW PITTMAN, LLP, P.O. BOX 10500, MCLEAN, VA, 22102, US

(73) Assignee: XEROX CORPORATION, Stamford, CT (US)

(21) Appl. No.: 11/155,642

(22) Filed: Jun. 20, 2005

(51) Int. Cl. G03G 21/12

(52) U.S. Cl. 399/360

(57) ABSTRACT

A magnetic vibration motor waste toner system configured to agitate and settle material in a waste toner container to allow for more even distribution of the material and increased material density.

### BACKGROUND

All references cited in this specification, and their references, are incorporated by reference herein where appropriate for teachings of additional or alternative details, features, and/or technical background.

Disclosed in the embodiments herein is a magnetic vibration motor waste toner system configured to agitate and settle material in a waste toner container to allow for more even distribution of the material and increased material density.

In the process of electrostatographic printing, an electrostatic charge pattern or latent image corresponding to an original document to be reproduced is recorded on an insulating medium. A viewable record is produced by developing the latent image with particles of granulated material to form a powder image thereof. Thereafter, the visible powder image is fused to the insulating medium, or transferred to a suitable support material and fused thereto. Development of the latent image is achieved by bringing a developer mix into contact therewith. Typical developer mixes generally comprise dyed or colored thermoplastic particles of granulated material known in the art as toner particles, which are mixed with carrier granules, such as ferromagnetic granules. When appropriate, toner particles are mixed with carrier granules and the toner particles are charged triboelectrically to the correct polarity. As the developer mix is brought into contact with the electrostatic latent image, the toner particles adhere thereto. However, as toner particles are depleted from the developer mix, additional toner particles (simply “toner” hereafter) must be supplied. In this way, the concentration of toner in the developer mix is maintained substantially constant.

In many xerographic dry toner development systems, waste material such as toner, carrier (which carries the toner and may assist in creation of the toner's triboelectric charge) and paper fiber is generated. Such waste material must be removed, for example, from the developer housings, photoreceptors and intermediate transfer belt through the use of cleaning systems that may be kept separate.

A variety of methods have been used in cleaning systems, to collect waste toner in cleaner waste bottles. Such methods include cleaning systems utilizing: augers to pack the toner into the waste bottle; augers to drop toner from the top of the bottle; a vacuum source with expensive toner separators and filter bags; and, toner dropping directly into the waste bottle. A disadvantage of these toner collection systems has been the distribution of toner in the waste bottle. Inappropriate toner distribution within the waste bottle prevents maximization of toner capacity in the waste bottle prior to removal from the cleaning system. For example, in direct drop cleaning systems, if many copies are run which have a large waste toner input to a particular location of the document, the corresponding location in the waste bottle will fill first. Another example occurs in cleaning systems with augers. Without a packing auger, the waste toner bottle fills unevenly due to the inability of the system to distribute the waste toner in the waste toner bottle.

In machines where the removal and replacement of waste containers is a task performed by a customer/user, it is highly desirable to have an accurate method for indicating when the waste container is full so that customers/users are not dissatisfied by replacing a waste container which is not fully used or by overflow of a full container.

The waste containers may be made from polypropylene or polyethylene. A natural color is generally chosen because the bottle is frequently used in conjunction with an optical sensor which indicates when the bottle is at its full capacity. These optical sensors may consist of an emitter and a detector which detect when the bottle is full by looking through a view window on the bottle or through the bottle directly. A problem with such systems is that toner contamination on the view window can trigger false readings and when the inside of the bottle becomes dusty, the sensor misinterprets this condition as a full bottle.

Due to machine architecture and space considerations, it is not uncommon that the design of the waste bottle is such that as waste material enters the bottle, uneven piles are formed instead of waste being evenly dispersed through the bottle. Uneven waste material distribution in a waste bottle may also result from the usage characteristics of a particular machine. For example, a multicolor machine primarily running black and white images will have a more uneven dispersion of material in the waste bottle than a machine running each color equally.

The possibility of uneven distribution in a multicolor machine can be appreciated by viewing a waste container such as set forth in FIG. 1 (prior art) and FIG. 2 (prior art). The waste container of such figures comprises a top waste funneling portion 10 comprising multiple waste funneling ports 25′, 25″, 25′″ and 25″″ and a bottom storage compartment 20. As shown in FIG. 2, bottom storage compartment 20 comprises common void 30 into which waste feeding from multiple funneling ports 25′, 25″, 25′″ and 25″″ are deposited. A sensor 12, such as shown in FIG. 1, interferes with common void 30 at one point to sense buildup of waste at that point. Of course, buildup of waste at this point may not be representative of the buildup situation at other points along bottom storage compartment 20, in particular if waste is predominantly funneled through one funneling port versus another.

Uneven waste material dispersion in the bottles can lead to premature waste bottle replacement and significant differences in the amount of material present in the bottles at replacement. In some cases, the waste bottles may only approximate 50% full when the machine process control detects that they are full and need to be replaced. Furthermore, material density may not be optimized in the waste bottle.

An alternative method that has been used in this type of application involves counting the number of copies since the bottle was last installed. This approach is not only indirect, but also inaccurate due to a wide variation in the amount of waste developer generated per copy. The inaccuracy correspondingly causes frequent bottle replacements and higher service costs. A system is needed to insure that a container of waste from a xerographic development process is truly full in order to prevent overflow and backup of waste into the development subsystem of a xerographic device and prevent too frequent servicing to remove the waste.

### REFERENCES

The following disclosures may be relevant to various aspects of the present invention and may be briefly summarized as follows:

U.S. Application Publication No. US 2003/0072577 A1 (U.S. application Ser. No. 09/975,785), commonly assigned, discloses a sensing system for detecting a full condition within a waste developer system, the sensing system including a developer waste container for receiving and holding waste developer material comprising toner and carrier deposited therein from the developer system; a sensor assembly mounted exterior to the developer waste container, the sensor including a reed switch being responsive to the level of material in the developer waste container when the material in the waste container reaches a predetermined level.

U.S. Pat. No. 5,534,988, commonly assigned, relates to an apparatus and method for preventing nonuniform accumulation of toner collected in a waste container of particles cleaned from a surface. The apparatus and method for disturbing the particles to provide uniform accumulation of toner in the waste container are driven by the same cam shaft, cam or solenoid used by the cleaner brushes for engaging and retracting the cleaner brushes from the surface. The waste container or cleaner subsystem is either thumped, moved back and forth, internally agitated or in some way disturbed to enable uniform toner distribution inside the waste container and better utilization of the storage capacity of the waste container.

U.S. Pat. No. 4,593,997 to Fox et al. discloses an apparatus for removing toner from a charge-retentive surface and collecting the toner in a receptacle for subsequent disposal thereof. This apparatus is characterized by the provision of a segmented auger structure which is disposed internally of the receptacle such that toner is moved into the receptacle through a vertical one end thereof and positively transported by auger action across the entire length of the receptacle.

U.S. Pat. No. 4,650,312 to Vineski discloses an apparatus for removing toner from a charge-retentive surface and collecting the toner in a receptacle for subsequent disposal thereof. This apparatus is characterized by the provision of structure for minimizing bridging or packing of toner in the flights of an auger forming a part of the removal and collection system as disclosed in the specification. The toner anti-bridging structure provides for imparting vibratory motion directly to the anger. To this end the anti-bridging includes a pendulum which is caused to periodically bang into the auger to create vibrations in the auger structure.

U.S. Pat. No. 4,739,907 to Gallant discloses a cylindrical developer storage and dispensing opening at one end that has an integral developer transport mixing and anti-bridging member rotatably supported within the container which has a first coiled spring element. This first coiled spring element has a cross section substantially the same as the cross section of the container and freely rotatable therein.

U.S. Pat. No. 4,943,830 to Sulenski discloses a developer dispensing apparatus that includes a coiled spring auger which is rotated through a developer bed in a direction to dispense developer through a dispensing opening. The spring auger has an unsupported free end which is nonfixedly placed over a hold down mechanism attached to one end of the developer housing and which projects inwardly into the toner bed. As the spring auger rotates, a tendency of the free end to vertically rise from the developer is inhibited by making contact with the hold down mechanism. By proper configuration of the contacting surface of the hold down mechanism, a thumping or anti-bridging action is imparted to the toner by periodically causing the coiled end to wind and unwind storing and releasing energy along the developer bed length.

### SUMMARY

Aspects disclosed herein include:

a system comprising a waste container structured to receive small particulate waste matter through one or more openings associated with the waste container; and a vibratory motor comprising an eccentrically-weighted rotor wherein the vibratory motor is operationally configured with respect to the waste container so as to provide vibrations to the waste container sufficient to substantially evenly distribute any small particulate waste matter entering through one or more openings;

a system comprising an electrostatographic device comprising a removable waste container structured to receive small particulate waste matter through one or more openings associated with the waste container; and a vibratory motor comprising an eccentrically-weighted rotor wherein the vibratory motor is operationally configured within the xerographic device so as to provide vibrations to the waste container sufficient to substantially evenly distribute any small particulate waste matter entering through one or more of the openings; and

a multicolor printing device having a sensing system for detecting a full condition within a waste system, the multicolor printing device comprising a waste container defining a void, the waste container comprising two or more inlets, each associated with an image receptor positioned so as to conduct waste produced in the printing process and communicate with the void; a vibratory motor comprising an eccentrically-weighted rotor, the vibratory motor being positioned and operationally configured within the multicolor printing device in a manner to provide vibrations to the waste container.

### BRIEF DESCRIPTION OF THE DRAWINGS

Various of the above mentioned and further features and advantages will be better understood from this description of embodiments thereof, including the attached drawing figures wherein:

FIG. 1 shows a perspective view of a prior art multicomponent multicolor waste container;

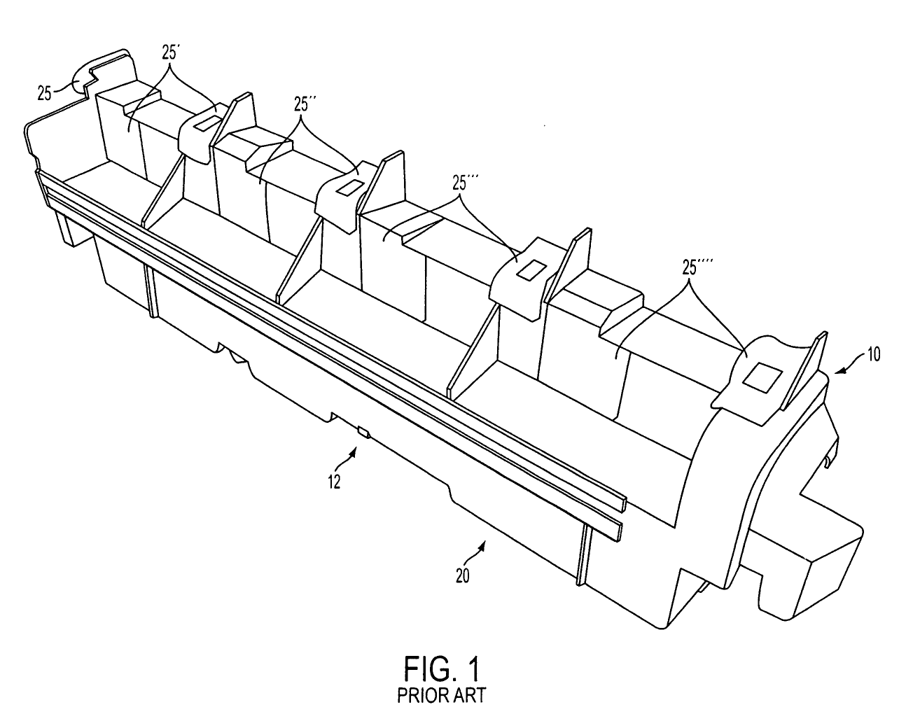

FIG. 2 shows a perspective view of the prior art multicomponent multicolor waste container of FIG. 1 with the top component removed from the bottom component; and

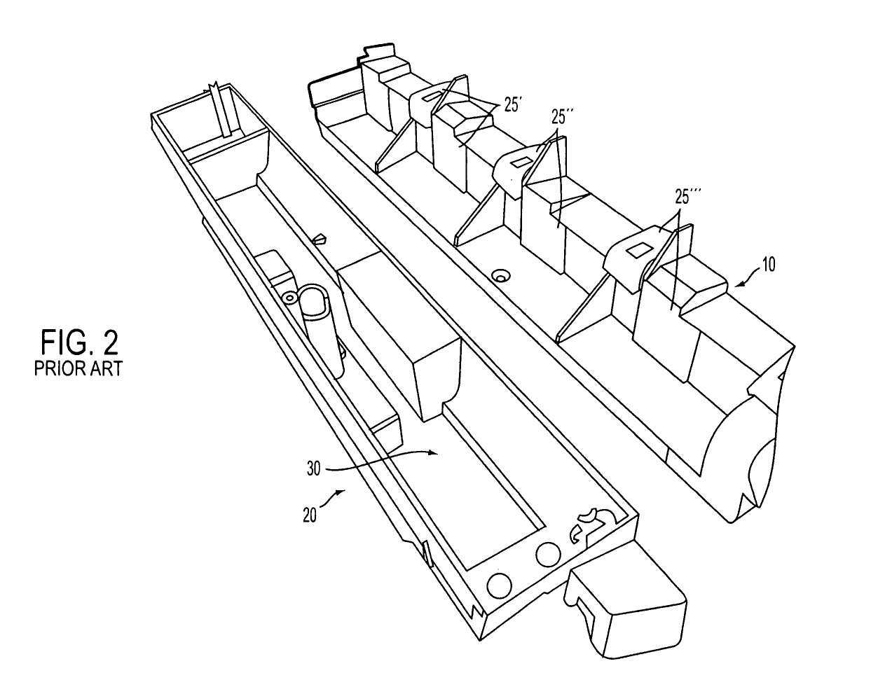

FIG. 3 shows a perspective view of a multicolor printing device incorporating a waste container embodiment of the present disclosure.

### DETAILED DESCRIPTION

In one embodiment, there is illustrated a system comprising a waste container structured to receive small particulate waste matter through one or more openings associated with the waste container; a vibratory motor comprising an eccentrically-weighted rotor wherein the vibratory motor is operationally configured with respect to the waste container so as to provide vibrations to said waste container sufficient to substantially evenly distribute any small particulate waste matter entering through one or more openings.

In another embodiment, there is provided a magnetic vibration motor that is used to agitate and settle material in a waste container, allowing for more even distribution of material in the waste container. The vibration motor may be permanently mounted in a printing device having need for a waste receptacle to capture waste produced in the printing process. It may be situated with respect to the waste container within the printing device to allow for vibration transfer to the waste container. The vibration received by the waste container should be of such magnitude to allow for more even distribution of waste material in the container and increased material density in storage than without the vibratory motor. In one embodiment, the motor provides vibrations sufficient to substantially provide even distribution of material in the void of the waste container receiving the waste material.

In yet another embodiment, the waste container comprises both a top portion and a bottom portion detachable from one another. The bottom portion may define a void for receiving the waste material while the top portion may comprise one or more conduits for funneling waste material to the void of the bottom portion.

In such embodiment, the waste container may have one or more openings, for example, four or more; the top portion and the bottom portion may be substantially patent (without holes, cracks etc.). The vibratory motor may be associated with, or provide vibrations preferentially to, either the bottom portion or top portion, or may provide vibrations equally to both portions. The vibratory motor may or may not be physically attached to either the top or bottom portion.

The waste container system may be used in conjunction with a number of printing and imaging devices that produce waste in the printing or imaging (collectively, “printing”) process. For example, such vibratory waste containers may find use in electrostatographic devices, such as xerographic machines, and in multicolor printing devices using small particulate toner or carrier, or which produce paper fiber waste.

In yet another embodiment, the vibratory motor is physically attached to the waste container. Attachment may be to the bottom portion and/or top portion, or may be at the interphase of the top and bottom portion.

The waste collected through the top portion may comprise, for example, small particulate matter such as toner or carrier or paper fibers shed in the printing process.

The system may make use of one or more sensors for detecting material levels in the waste container. The sensor(s) may be positioned so as to relate to a particular fill level of the waste container.

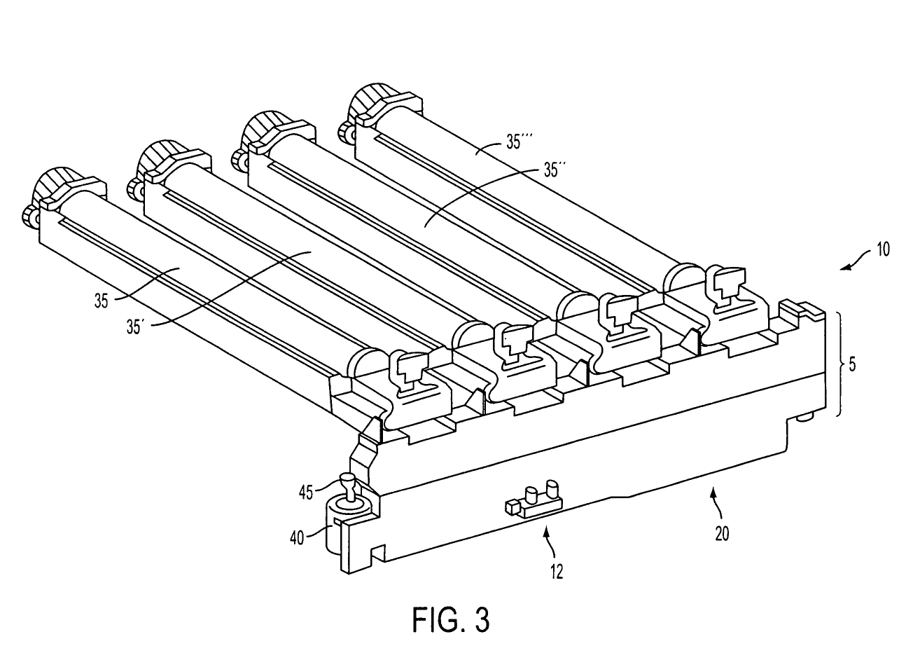

Now turning to FIG. 3, there is shown a perspective view of a multicomponent waste container system associated with a vibratory motor. Such system comprises a plurality of print cartridges 35, 35′, 35″ and 35′″, each housing toner carrier designed to produce a particular color. Excess toner that is generated in the printing process is funneled through top portion 10 of waste container 5 through one or more conduits 25′, 25″, 25′″ and 25″″ into bottom portion 20 defining a void for storing the waste material. Vibratory motor 45 is positioned with respect to waste container 5 to provide vibrations thereto. Sensor 12 senses the condition of fill of bottom portion 20.

While the invention has been particularly shown and described with reference to particular embodiments, it will be appreciated that variations of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

1. A system comprising:
a waste container structured to receive small particulate waste matter through one or more openings associated with the waste container; and
a vibratory motor housing an eccentrically-weighted rotors the vibratory motor being operationally configured to agitate the waste container to substantially evenly distribute any small particulate waste matter entering through the one or more openings of the waste container.

2. A system in accordance with claim 1 wherein the waste container has two or more of the openings.

3. A system in accordance with claim 1 wherein the waste container comprises a top portion containing one or more openings and a substantially patent bottom portion.

4. A system in accordance with claim 3 wherein the top portion and the bottom portion are separate components detachable from one another.

5. A system in accordance with claim 3 wherein the bottom portion defines a void in communication with the one or more openings of the top portion.

6. A system in accordance with claim 5 wherein the vibratory motor is attached to the bottom portion.

7. A system in accordance with claim 5 wherein the vibratory motor is attached to the top portion.

8. (canceled)

9. An electrostatographic device comprising:
a removable waste container structured to receive small particulate waste matter through one or more openings associated with the waste container;
a vibratory motor housing an eccentrically-weighted rotors,
wherein the vibratory motor is operationally configured within the electrostatographic device to agitate the waste container to substantially evenly distribute any small particulate waste matter entering through one or more of the openings of the waste container.

10. A device in accordance with claim 9 wherein the removable waste container comprises a top portion containing one or more openings and a substantially patent bottom portion.

11. A device in accordance with claim 9 wherein the top portion and the bottom portion are separate components detachable from one another.

12. A device in accordance with claim 9 wherein the vibratory motor is not attached to the waste container.

13. A device in accordance with claim 9 wherein the vibratory motor is attached to the waste container.

14. A device in accordance with claim 10 wherein the vibratory motor is configured to provide vibrations preferentially to the bottom portion of the waste container as opposed to the top portion of the waste container.

15. (canceled)

16. A multicolor printing device having a sensing system for detecting a full condition within a waste system, said multicolor printing device comprising:
a waste container defining a void area for collecting waste produced during a printing process, the waste container comprising two or more inlets, each inlet associated with an image receptor positioned so as to route the waste to the void area;
a vibratory motor housing an eccentrically-weighted rotor, the vibratory motor being positioned and operationally configured within the multicolor printing device to agitate the waste container to substantially evenly distribute the waste collected by the void area.

17. A multicolor printing device in accordance with claim 16 wherein the waste container comprises four or more of the inlets.

18. A multicolor printing device in accordance with claim 16 wherein the waste container comprises a top portion comprising the inlets and a substantially patent bottom portion.

19. A multicolor printing device in accordance with claim 18 wherein the waste container top portion and bottom portion are separate components detachable from one another.

20. A multicolor printing device in accordance with claim 18 wherein the vibratory motor is positionally associated with the bottom portion of the waste container when the waste container is positioned in the multicolor printing device.
